(19) United States
(12) Patent Application Publication
(10) Pub. No.: US 2026/0266434 A1
(43) Pub. Date: Sep. 10, 2026

(54) LIGHT EMITTING DEVICE

(71) Applicant: SIGNIFY HOLDING B.V., EINDHOVEN (NL)

(72) Inventors: TIES VAN BOMMEL, HORST (NL); RIFAT ATA MUSTAFA HIKMET, EINDHOVEN (NL)

(21) Appl. No.: 19/164,632

(22) PCT Filed: Mar. 7, 2024
(86) PCT No.: PCT/EP2024/056008

§ 371 Date: Sep. 12, 2025

(30) Foreign Application Priority Data
Mar. 14, 2023 (EP) 23161689.7

(51) Int. Cl. F21K 9/61; F21K 9/232; F21K 9/64; F21V 8/00

(52) U.S. Cl. CPC F21K 9/61; F21K 9/232; F21K 9/64; G02B 6/0006; G02B 6/001

(57) ABSTRACT

The invention relates to a lighting device comprising an envelope, a base, a solid-state light source, an exhaust tube, and a light guide provided with a light-outcoupling means. The light guide is optically coupled to said solid-state light source and partially arranged inside the exhaust tube. The high performance of the laser light source, as a solid-state light source, with the interaction of the optical fiber, as a light guide with the exhaust tube comprised in the stem, will make this lighting device more performant and improve its functionality and/or performance.

### FIELD OF THE INVENTION

The present invention relates to the fields of light-emitting devices and, more particularly, to lamps using an envelope, and using optical fibers to transport light.

### BACKGROUND OF THE INVENTION

Various conventional lighting sources, such as Edison-type light bulbs, may provide lighting for various lighting applications. However, conventional lighting sources may have drawbacks, such as high energy consumption, low performance, short useful life, restricted functionality and appearance, limited variety of colors and luminosity, etc. That is why filament lamps' performance, functionality and/or appearance have been topics of interest.

Optical fibers are used in a wide variety of applications in which light is delivered from a light source to a target region. For example, in some applications, such as lighting, signage, biological applications, etc., light-diffusing optical fibers may be utilized such that light propagating through the light-diffusing optical fiber is scattered radially outward along a length of the fiber, thereby illuminating the target region along the length of the fiber. However, existing light-diffusing optical fibers fail to provide satisfactory illumination characteristics for some applications.

Accordingly, a need exists for alternative light-diffusing optical fibers and light-emitting apparatuses that include light-diffusing optical fibers. To overcome these obstacles and challenges, it is necessary to develop new lamps that have improved performance and functionality without worsening their appearance and increasing their manufacturing complexity and, therefore, their cost.

It is an object of the present invention to provide a lighting device which does not have these drawbacks and in which the light emitted by the solid-state light source is used directly for lighting purposes. A further advantage of the present invention is improving filament lamps' performance, functionality and/or appearance.

US 2013/265796 discloses a lighting device and a method of manufacturing such a lighting device. The lighting device comprises a first light emitting element being optically coupled to a light guide having an out-coupling surface for illumination via the light guide. Further, the lighting device comprises a second light emitting element dedicated for direct illumination from the lighting device. The invention is advantageous in that the lighting device provides both a decorative look and a functional illumination and is still energy-efficient since the light emitted from the second light emitting element is directly emitted from the light emitting element without unnecessary energy-loss.

### SUMMARY OF THE INVENTION

The present invention is related to a lighting device providing device light and comprising at least:
a light-transmissive envelope;
a stem at least partly arranged inside the envelope, at least part of the stem defining a first volume while a second volume is defined between the stem and the envelope;
a light guide having a melting temperature (Tm1) higher than the melting temperature of the stem (Tm2) and the melting temperature (Tm1) of the light guide is higher than the melting temperature (Tm3) of the envelope, said light guide being partly arranged inside the first volume, partly arranged inside the second volume, and partly arranged outside the first volume and the second volume;
a solid-state light source providing light source light and being arranged outside the first volume and second volume;
wherein at least part of the light source light is coupled into the light guide at a first end of a light guide portion being arranged outside the first volume and the second volume, and is light-guided via total internal reflection (TIR) through the light guide to a light guide portion that is arranged inside the first volume;
wherein the light guide portion of the light guide, which is arranged inside the first volume, comprises one or more light outcoupling means configured to couple light-guided light out the light guide as outcoupled light into the first volume.

Subsequently, at least part of the outcoupled light is transmitted through the light-transmissive envelope as the device light.

In general, traditional incandescent light bulbs are manufactured using a stem, a glass envelope and an incandescent wire for emitting the light. In the standard production process the glass parts has to be melted together and the bulb must be airtight sealed. This process requires high operating temperatures.

It appears beneficial to produce modern LED based light bulbs on existing manufacturing equipment of incandescent lamps. However, the high operating temperatures may damage the light guide as used in the lighting device of the present invention. The present invention gives a solution for this technical problem by carefully designing a lighting device with a solid-state light source and a lightguide for emitting the light for which it is necessary to have a lightguide with a melting temperature Tm1 that is higher than both the melting temperature of the stem Tm2 and of the envelope Tm3.

Preferably, the first volume may be gas tightly sealed by the envelope and comprises optionally a gas, preferably an inert gas.

The second volume may be sealed and comprise a gas, preferably an inert gas. Preferably, the light guide comprises at least an optical fiber comprising a core and a cladding, wherein the cladding has a refractive index lower than the said core.

Preferably, the melting temperature of the core (Tm1a) and the melting temperature of the cladding (Tm1b) are higher than the melting temperature of the stem (Tm2) and optionally higher than the melting temperature of the envelope (Tm3).

Preferably, the light guide comprises silica, fluorine-doped glass and/or quartz. Preferably, the stem comprises an exhaust tube defining a defined volume wherein the light guide) is partly arranged inside.

Preferably, the solid-state light source comprises a laser light source.

Preferably, the out-coupled light is white light having a correlated color temperature range from 1500K to 6500K and having a color rendering index of at least 80.

Preferably, the light source light is a blue light source light, and wherein the light out-coupling means comprises a light converting material to at least partly convert blue light source light into a converted light.

Preferably, the solid-state light source is arranged in a base of the lighting device; said base is configured to electrically and mechanically connect the lighting device to a luminaire socket.

Preferably, the light out-coupling means comprise reflective elements, scattering elements, refracting elements and/or diffractive elements arranged in or on the surface of the light guide.

Preferably, the light guide portion inside the enclosed volume has a spiral or helix shape.

Preferably, the light source light is emitted by the solid-state light source in a direction away from an inner surface of the envelope.

The present invention is also related to a lamp or luminaire comprising the lighting device as described here above.

### BRIEF DESCRIPTION OF THE DRAWINGS

This and other aspects of the present invention will now be described in more detail, with reference to the appended drawings showing the preferred embodiment(s) of the invention. The figures presented in this invention by way of example, and not by way of limitation, in the accompanying drawings, wherein:

FIG. 1 schematically depicts a lighting device including a light guide having a coiled filament partly arranged inside a stem comprising an exhaust tube;

FIG. 2 schematically depicts a lighting device including a light guide having a coiled filament partly arranged inside a stem comprising an exhaust tube and a base showing a solid-state source;

FIG. 3 schematically depicts a lighting device including a light guide having a coiled filament partly arranged inside a stem comprising an exhaust tube and a base showing two solid-state sources;

FIG. 4 schematically depicts a lighting device including two light guides having a coiled filament partly arranged inside a stem comprising two exhaust tubes and a base showing a solid-state source;

FIG. 5 schematically depicts a lighting device including a light guide with a coiled filament partly arranged inside a stem comprising an exhaust tube and a base showing a solid-state source. A. schematically depicts a cross-section of light-diffusing optical fiber having a core and a cladding;

FIG. 6 schematically depicts a lighting device including two light guides having a coiled filament partly arranged inside a stem comprising an exhaust tube and a base showing a solid-state source;

FIG. 7 schematically depicts a lighting device including a light guide having a coiled filament partly arranged inside a stem comprising an exhaust tube according to another embodiment shown and described herein;

FIG. 8 schematically depicts a lighting device including a light guide having a coiled filament partly arranged inside a stem comprising an exhaust tube according to another embodiment shown and described herein;

FIG. 9 schematically depicts a lighting device including a light guide having a coiled filament partly arranged inside a stem comprising two exhaust tubes according to another embodiment shown and described herein;

FIG. 10 schematically depicts a lighting device including a light guide having a coiled filament partly arranged inside a stem comprising an exhaust tube according to another embodiment shown and described herein; and

FIG. 11 schematically depicts a lighting device including a light guide having a coiled filament partly arranged inside a stem comprising an exhaust tube installed in a luminaire.

### DETAILED DESCRIPTION

Reference will now be made in detail to various embodiments of the lighting device, including optical fibers as light guides that are partially arranged inside one or more exhaust tubes, examples of which are illustrated in the accompanying drawings. Whenever possible, the same reference numerals will be used throughout the drawings to refer to the same or like parts.

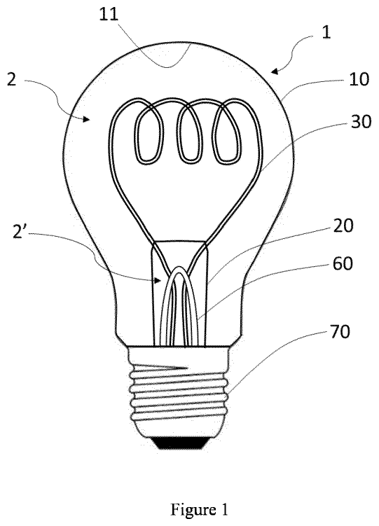

FIG. 1 schematically depicts a lighting device 1 includes a base 70, a light guide 30 including an optical fiber having a spiral shape. In addition, the lighting device 1 has a translucent envelope 10, preferably made of glass, familiar to the well-known light bulb. It is noted that the meaning of the word translucent also includes transparent. The envelope 10 may contain air or some other gases in a second volume 2. Preferably, at least 60% of the gases comprise an inert gas such as Helium. The envelope 10 may be connected to the base 70 that forms a screw base or a bayonet base on its outside to make it compatible with replacing any light bulb.

The translucent envelope 10 may be formed from any translucent material. For example, in some embodiments, the translucent envelope 10 may be formed from plastic or glass. In some embodiments, the translucent envelope may be frosted glass. The translucent enclosure 10 may be clear or may be colored. In some embodiments, the translucent envelope 10 is coated with a fluorescent or scattering material. The envelope 10 is light-transmissive and comprises a second volume 2. Inside this second volume 2, a stem 20, preferably made of glass, more preferably made of soda lime glass, is placed defining a first volume 2′. Different shapes of exhaust tube 60, preferably made of glass, may be placed inside the stem to host part of the light guide 30.

By coating the inner surface 11 of the envelope 10 with a luminescent material, it will be possible to make an even wider variety of colored lamps, even when only one solid-state light source is used.

The lighting device 1 preferably has a base 70 configured to electrically and mechanically connect the lighting device 1 to a socket 90 of a luminaire 100. This base 70 may comprise a cap. Most present-day conventional light bulbs are provided with a screw base like the well-known E5, E10, E11, E12, E14, E17, E26, E27, E29, E39, E40 base, or an automotive light base, or the like base, or a bayonet base. By providing a lighting device according to the present invention with the same base type. It is compatible with existing light bulbs, so replacing the existing lamp with the new lighting device is straightforward.

Furthermore, the base 70 of the lighting device 1 may comprise electronic components or electronic driving means provided with a power supply for driving the solid-state light source 40. These electronic driving means or components will transfer the mains voltage input of the lighting device 1 into an output value suitable for driving a solid-state light source 40. Additionally, they are further provided with a control unit arranged to control the light output and/or the color of the said lighting device 1. This feature may also control the light intensity.

Reference through the specification to “light guide” means any material that can emit and or diffuse light. Therefore, using optical fiber as an example does not limit the scope of the present invention, and other types of fibers or filaments may be employed as a light guide. According to the preferred embodiment, at least one optical fiber is used as light guide for the lighting device.

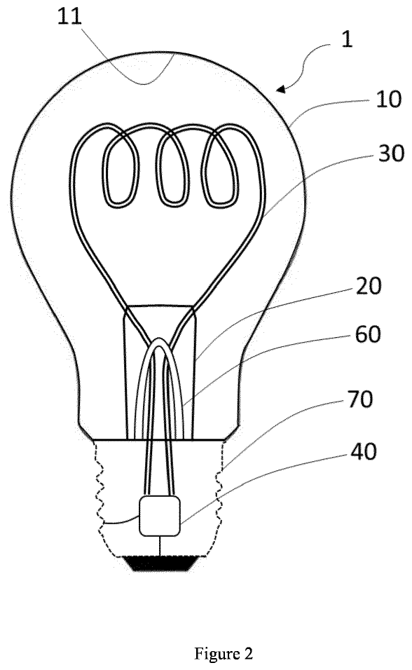

FIG. 2 schematically depicts a lighting device 1 with a view of the base 70.

The light guide or specifically the optical fiber 30 is coupled to a solid-state light source 40, such as, for instance, one or more laser light sources and electronic components for transforming the main voltage input, 230V AC or 110V AC, into a signal suitable for driving the solid-state light source 40. In operation, the solid-state source 40 emits light and transmits this light to the optical fiber 30.

The lighting device 1, according to the present invention, may emit light by a solid-state light source 40. This solid-state light source 40 may be LED, preferably a laser light source that is transferred to the light guide 30 by optical coupling. The light guide 30 may have a melting temperature (Tm1) higher than the melting temperature of the stem 20 (Tm2) and the melting temperatures of the envelope 10 (Tm3).

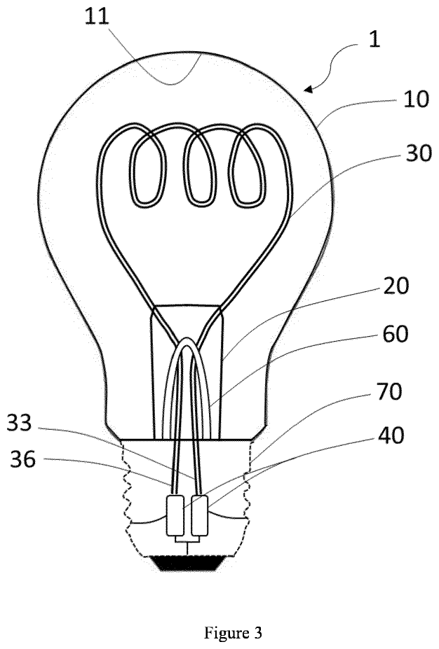

The invention is based on the recognition that it will be possible to transfer the light emitted by a solid-state light source 40 that is arranged outside the second volume 2 of the envelope 10 to the light guide 30 by optical coupling said solid-state light source 40 to the at least one end 33 or 36 of the light guide 30 (FIG. 3). These one or more light guides form a separate element inside the lighting device and are not integrated with the envelope 10. Furthermore, one or more light guide 30 have to be provided with a light outcoupling means 35 which allow outcoupling of the light from said light guide 30. This can be achieved by choosing appropriate reflective elements, scattering elements, refracting particles and/or structures, and/or diffractive elements arranged in or on the surface of the light guide.

In this manner, the lighting device 1, according to the present invention, will emit the light from the solid-state light source 40 with the same spectral distribution as generated by said solid-state light source 40.

In a preferred embodiment, the solid-state light source 40 comprises at least one laser light source. The performance and functionality of laser lights make them an excellent light source choice for these types of lighting devices; by using the laser light and light converting materials comprising, for example, two luminescent materials, the color of the lighting device is determined by choice of the light converting materials used in the light outcoupling means 35. For instance, by using a first luminescent material comprising a green-yellow phosphor such as YAG and/or LuAG, a blue light source light may be converted into a green-yellow converted light. Whereas, using a second luminescent material comprising a red phosphor such as BSSN, ECAS, KSF, a blue light source light and or green-yellow converted light may be converted into converted red light.

In a further embodiment, the solid-state light source 40 comprises more than one solid-state light source 40, in operation, emits laser light source of different colors. The use of three laser light colors provides the possibility of choosing the desired color from a large color gamut in the 1931 CIE Chromaticity Diagram: that is, all the colors enclosed by the triangle, with the colors of the three laser light sources, preferably three laser light sources of the three primary colors, like for instance red, green and blue. Moreover, by changing the ratio of the intensities between the differently colored laser lights, all the colors within said triangle can be adjusted.

In further embodiments, the light guide 30 comprises an optical fiber, which may be in a spiral or helix shape. The use of optical fibers allows a large variety of very decorative lamps or luminaires. One or both ends 33 or 36 of the light guide 30 have to be optically coupled to the solid-state light source 40 and partly arranged inside the exhaust tube 60 that is arranged inside the stem 20. When more than one solid-state light source 40 is used, it is possible to use only one optical fiber 30, which is coupled to more than one solid-state light source 40. The optical fiber 30 thus receives and emits the light generated by the solid-state light source 40. Alternatively, it is possible to use separate optical fiber 30. Consequently, the lamp or luminaire may have more than one optical fibers 30, each emitting the same or different light color. It is also possible to couple one or both ends 33, 36 of the optical fiber 30 to one or more than one solid-state source 40. The coupling of the two ends 33, 36 of the optical fiber 30 allows a more homogeneous light distribution across the optical fiber 30.

Referring to FIG. 3, more than one solid-state light source 40 may be added in the lighting device 1 to emit different light colors with wide wavelength ranges. The one or more solid-state source 40 is optically coupled to the light guide 30 by at least one of the ends 33 and 36 of the light guide 30. In some embodiments, the solid-state light source 40 may be directly coupled to only one end 33 or 36 of the light guide 30. In some embodiments, the solid-state source 40 may include a laser source such as a laser diode and/or a light-emitting diode. In some embodiments, the light source 40 may include more than one laser diode and/or more than one light-emitting diode. The solid-state source 40 is preferably affixed to the base 70.

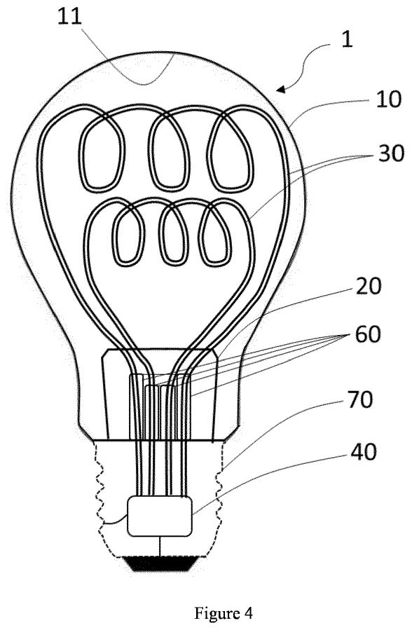

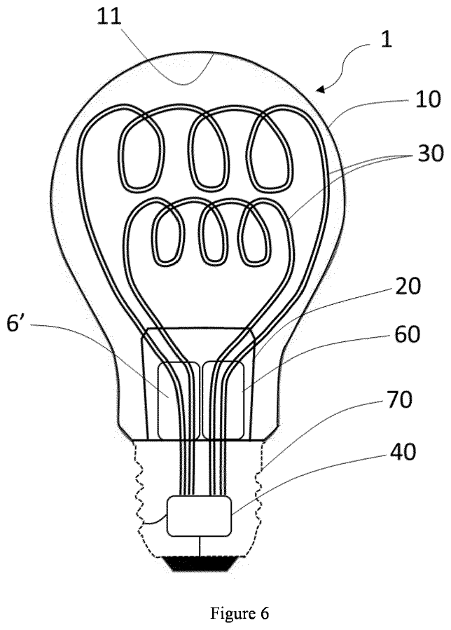

The light guide 30 comprises an optical fiber 30, which may be shaped in a variety of forms, for example, spirally wound. At least one of the ends 33 and 36 of the optical fiber 30 is optically coupled to the solid-state light source 40. More than one optical fiber 30 may be used and coupled to one solid-state light source 40 (FIGS. 4 and 6).

Alternatively, it is possible to use more than one optical fiber 30, coupled separately to each solid-state light source 40. It is also possible to couple one or both ends 33 and 36 of the optical fiber 30 to one or more light sources 40.

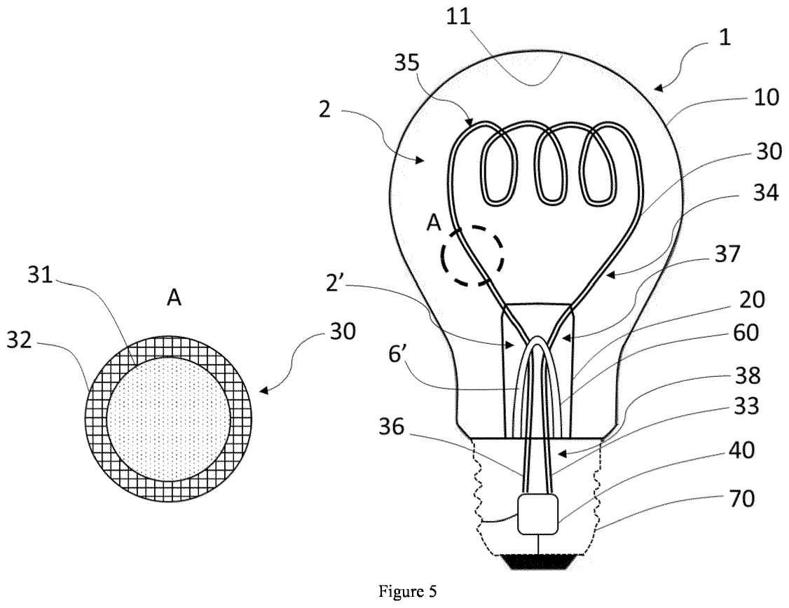

The light guide 30 may be defined into three parts (FIG. 5); a first part that is arranged inside the second volume 2 of the envelope 10 (portion 34), a second part that is arranged in the first volume 2′ of the stem, preferably passes at least partially through the exhaust tube 60 (portion 37), and a third part that is arranged outside the second volume 2 of the envelope 10 which is coupled with the solid-state source 40 (portion 38). The exhaust tube 60 may define a defined volume 6′ wherein the light guide 30 is partly arranged inside. The volume 6′ may comprise a gas, preferably an inert gas, tightly sealed.

The optical fiber 30 is provided with a light-outcoupling means 35 comprising reflective elements, scattering elements, refracting particles and/or structures, and/or diffractive elements arranged in or on the surface due to which the light is emitted from the optical fiber 30. Reflective particles or bubbles may also be comprised in these light-outcoupling means 35 covering the cladding 32 of the optical fiber 30. This light-outcoupling means 35 may be designed so that the optical fiber 30 emits the light homogeneously throughout its surface. The light outcoupling means 35 configured to couple light-guided light out the light guide 30 as outcoupled light into the volume 2. The outcoupled light may be a white light with a correlated color temperature range from 1500K to 6500K and a color rendering index of at least 80. Alternatively, for optical fibers 30 with spiral or helix shapes, it may be designed to emit relatively more light from the spiraled part and less from the non-spiralled parts, forming the connection between the spiralled part and the solid-state light source 40. Furthermore, the choice of the materials as mentioned above, the choice of the surface roughness along the optical fiber 30 may also be beneficial to emit more light and make the emission along the optical fiber 30 of the lighting device 1 strongly resemble to the emission of a carbon filament lamps or conventional lamps in general.

Referring again to FIG. 3, each end 33 and 36 of the optical fiber 30 are connected to one solid-state light source 40. The light emitted by said solid-state light source 40 now enters the optical fiber 30 on both sides, leading to a more homogeneous light distribution across the optical fiber 30. Alternatively, only one of the ends 33 or 36 of the optical fiber 30 can be optically coupled to the solid-state light source 40, in which case the other end 33 or 36 is not in optical contact with the solid-state light source 40.

A further option is to optically couple the end 33 or 36 of the optical fiber 30 to more than one solid-state light source 40, thus allowing a higher light output of the lighting device 1.

In FIG. 3, the light emitted by the two solid-state sources 40 may be mixed before it enters the light guide 30, such as, for instance, the optical fiber 30. Each of the two solid-state light sources 40 may comprise a laser light source with the same or different color. These colors may be mixed by a light scattering element which may be placed in the stem 20 and is in optical contact with the laser light sources 40. The ends 33, 36 of the optical fiber 30 may be in optical contact with a light-scattering element to pick up the homogenious mixed light.

FIG. 5 shows a cross-section A of the optical fiber 30 that may comprise a core 31 and a cladding 32. Preferably, the refractive index of the cladding 32 is lower than the reflective index of the core 31, and the melting temperature of the core 31 (Tm1a) and the melting temperature of the cladding 32 (Tm1b) are higher than the melting temperatures of the stem 20 (Tm2) and optionally the envelope 10 (Tm3). It is also preferred that the optical fiber 30 comprises silica, fluorine-doped glass and/or quartz. Thoroughly, the fluorine-doped glass may be used for the cladding 32 and quartz for the core 31. The optical fiber 30 is arranged through the exhaust tube 60 so that at least a portion of the optical fiber 30 takes part of the exhaust tube 60. In more detail, the stem 20 comprises at least one exhaust tube 60, which encloses a gas in a volume. Therefore, at least a portion of the at least one optical fiber 30 passes through the exhaust tube 60 by the said gas in the said volume of the exhaust tube 60.

FIG. 4 shows another embodiment of the present invention showing the stem 20 that may comprise more than one exhaust tube 60. The optical fiber 30 may be arranged through the same exhaust tube 60 or through more than one exhaust tube 60, and each end 33 or 36 may be arranged through a different exhaust tube 60. If more than one optical fiber 30 is employed, they may be arranged through the same exhaust tube 60, or each optical fiber 60 may be arranged in a separate exhaust tube 60, or each exhaust tube 60 may contain more than one end 33 or 36 of different optical fibers 30.

FIGS. 4 and 6 show that more than one optical fiber 30 is used and connected to the same solid-state source 40. However, every optical fiber 30 may comprise a solid-state source 40, and the optical fiber 30 may be optically connected to more than one solid-state source 40, one solid-state source 40 for each end 33. 36. The optical fiber 30 is partially arranged inside the envelope 10, partially arranged outside the envelope 10, and partially inside the stem 20, more precisely inside the exhaust tube 60 that constitutes part of the stem 20. More than one optical fiber 30 may be arranged inside the same exhaust tube 60. Alternatively, each optical fiber 30 may be arranged inside at least one exhaust tube 60. In other words, each end 33, 36 of the optical fiber 30 may be arranged in one exhaust tube 60 having one sealed first volume 2′ or having more than one separate first volume 2′, one first volume 2′ for each end 33, 36. When the optical fiber 30 is arranged inside more than one exhaust tube 60, each end 33, 36 is arranged in a different sealed first volume 2′ existing in two different exhaust tubes 60.

The optical fiber 30 can be coupled to each solid-state light source 40, similar to the case of only one solid-state source 40. However, this lighting device 1 has an even higher value because it will have more than one optical fiber 30, and each may emit light of a different color.

The interior of the lighting device 1 comprises a solid-state light source 40, such as, for instance, one or more laser light sources, electronic components, and electronic driving mean for transforming the mains voltage input 230 V AC or 110 V AC into a signal suitable for driving the solid-state light source 40.

The lighting device 1 further has an optical fiber 30 coupled to the solid-state light source 40. In operation, the solid-state light source 40 emits light and transmits this light to the optical fiber 30 via total internal reflection (TIR) to a light guide portion 34 of the light guide 30 being arranged inside the second volume 2. The optical fiber is provided with a light outcoupling means 35, due to which the light is emitted from the optical fiber. These light-outcoupling means 35 may be designed in such a way that the optical fiber 30 emits the light homogeneously throughout its surface. Alternatively, an optical fiber 30 with a spiral or helix shape may be designed to emit relatively more light from the spiralled part than from the relatively straight part, forming the connection between the spiralled part and the solid-state light source 40. This may be accomplished, for instance, by the choice of reflective elements and/or scattering elements and/or refracting particles and/or structures, and/or diffractive elements arranged in or on the optical fiber 30. In this way, the emission along the optical fiber 30 will strongly resemble the emission of a carbon filament lamp.

When the solid-state source 40 is energized, light emitted from the solid-state light source 40 is optically coupled to the light guide 30, such that at least a portion of the emitted light enters the light guide 30. In this embodiment, an optical fiber 30, and is scattered away from the core 31 and through the cladding 32 of the optical fiber 30 that has a spiral or helix shape. At least one of the optical fibers 30 comprises one or more outcoupling means 35. Such lighting device 1, which emits light from the optical fiber 30 enclosed within the translucent envelope 10, may have better performance than, may consume less power than, and may have better functionality and/or appearance than a conventional light bulb e.g. Edison-type.

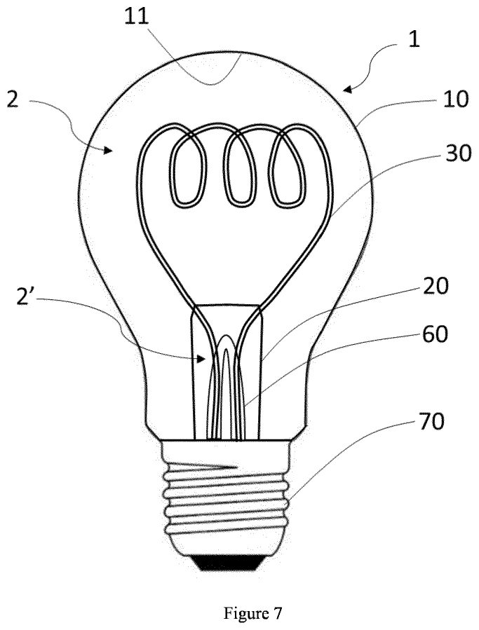

FIG. 3 and FIG. 7 show an embodiment with an optical fiber 30 arranged partly inside the exhaust tube 60. However, depending on the form and size of the exhaust tube 60 as well as the desired lighting output, the portion where the optical fiber 30 intersects the exhaust tube 60 may be defined differently. In FIG. 7, a more extended portion of optical fiber 30 is arranged inside the exhaust tube 60, allowing more interaction of the optical fiber 30 with the environment of the exhaust tube 60. In more detail, the optical fiber 30 may interact with the gas present in the exhaust tube 60 that is sealed in a first volume inside the stem 20.

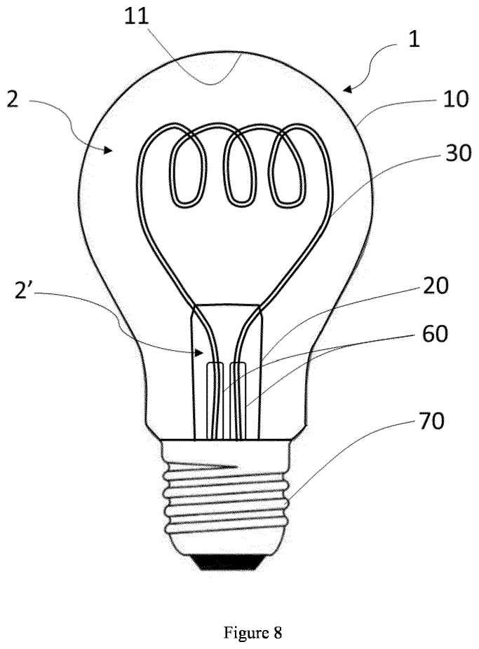

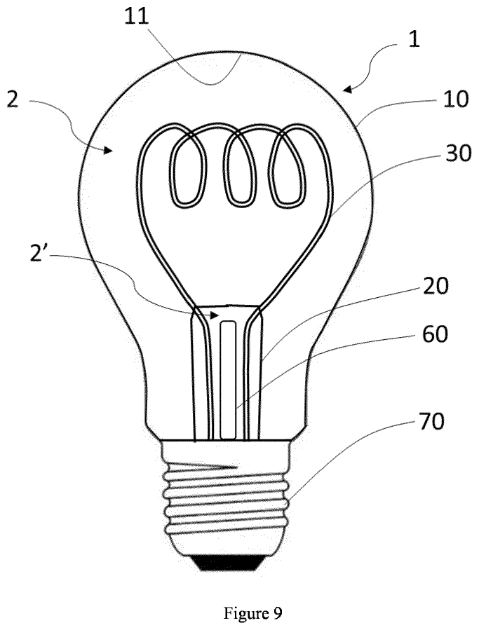

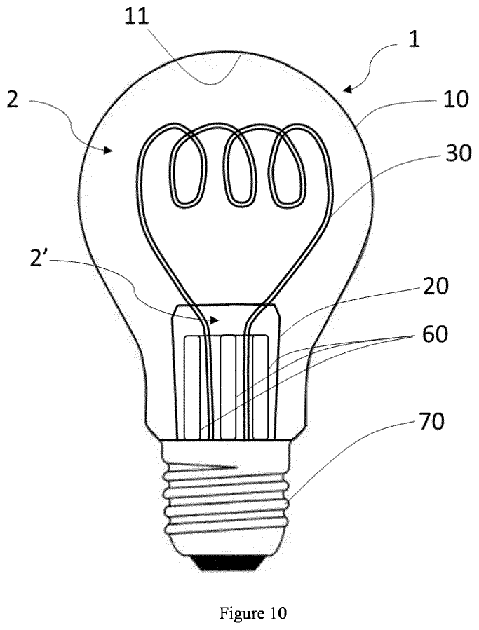

FIGS. 8, 9, and 10 show different embodiments of the exhaust tube 60. The stem 20 may comprise more than one exhaust tube 60 connected or separated. Each exhaust tube may comprise a same or different gas in a second volume, preferably an inert gas. The exhaust tube 60 is not limited to a shape in the form of a tube but may also form other forms. Most importantly, part of the light guide 30 may be partially arranged inside the exhaust tube 60. This arrangement is not limited to one straight portion of the optical fiber 30, but it may also be partially arranged inside the exhaust tube 60 by more than one portion of the same or different ends 33, 36, for example, by not limited to a spiral shape or serpentine shape.

The exhaust tube 60 may be added to the lighting device 1 which uses one or more optical fibers 30 to help dissipate heat generated by the solid-state light source 40. Heat can be a problem in lighting devices as it can shorten their life and create safety hazards.

The exhaust tube 60 may allow heat to be drawn away from the optical fiber 30 and, therefore, the solid-state light source 40 reducing the temperature inside the lighting device and prolonging its lifetime. The exhaust tube 60 may also be used to dissipate heat and cool the optical fiber 30, making the lighting device more efficient and reliable. Ventilating systems or setups may be used for cooling the solid-state light source 40 or the optical fiber 30. In this way, the exhaust tube 60 can be used to both dissipate heat and cool the optical fiber 30 and/or the solid-state source 40, making the lighting device 1 more efficient and reliable.

The reaction between the exhaust tube 60 and the optical fiber 30 in lighting device 1 will depend on the specific application and design of the lighting device 1. In general, the exhaust tube 60 may not directly react with the optical fiber 30 itself, as the fibers are typically made of glass or plastic and are used to transmit light, while the exhaust tube is used to vent heat. However, the exhaust tube 60 may indirectly impact the optical fiber 30. For example, if the exhaust tube 60 is used to vent heat from the light source, it could help to prevent the heat from damaging the one or more optical fibers 30 or causing them to warp or bend. This helps ensure that the light is transmitted through the optical fibers 30 with minimal loss or distortion, which may improve the overall performance of the lighting device 1. It's also possible that the exhaust tube 60 may be used to vent any other byproducts of the lighting device 1 that could cause damage to the one or more optical fibers 30 or even make them useless.

Overall, the exhaust tube 60 in the lighting device 1 that uses one or more optical fibers 30 will play a supportive role in maintaining the integrity and performance of the optical fibers 30 by removing any potential heat or harmful gases or byproducts that may come in contact with the optical fibers 30.

If the envelope 10 is made of transparent and/or translucent material, preferably glass, this lighting device 1 will have a high decorative value. Using a laser light source 40 and an optical fiber 30 with a spiral or helix shape, this lighting device 1 will strongly resemble the well-known carbon filament lamps frequently used for lighting. However, the carbon filament lamp has the drawback that it is expensive and vulnerable and has very low luminous efficacy. The lighting device 1, according to the present invention, overcomes these drawbacks: it can be used to create a nice color light while providing high light output, together with an extremely long lifetime.

A further feature that may be incorporated in the lighting device 1 is an inner surface 11, which may be a coating of luminescent material. The coating can change the color of the light emitted from the solid-state light source 40. Furthermore, the appearance of the lighting device 1, when the envelope 10 is bulb-shaped, will be a look-alike of the diffuse incandescent lamp. Therefore, these lighting devices are very suitable for replacing incandescent lamps.

It is advantageous when a lighting device 1, according to the present invention, can be used as a replacement for the commonly used incandescent lamps. It is, therefore, preferred that the base 70 of the lighting device 1 is a screw base or a bayonet base. Particularly screw bases of the type E5, E10, E11, E12, E14, E17, E26, E27, E29, E39, E40, an automotive light socket or the like frequently used for lamps.

For the lighting device 1 to be fully compatible with the standard incandescent lamp, it is required that said lighting device 1 contains electronic components or electronic driving means provided with a power supply for converting the mains voltage supply, usually 230V AC or 110V AC, into an output signal suitable for driving a solid-state light source 40. Additionally, these electronic components or electronic driving means may contain electronic circuitry for controlling the color and intensity, light output, and/or settings of the lighting device 1. The color and intensity may be controlled by a remote control unit, buttons on the base 70 or another type of user interface.

To this end, the electronic components or electronic driving means may comprise a power supply and a control unit for intensity and color settings. These electronic components or electronic driving means can be provided in the base 70. In addition, this base 70 may comprise a cap.

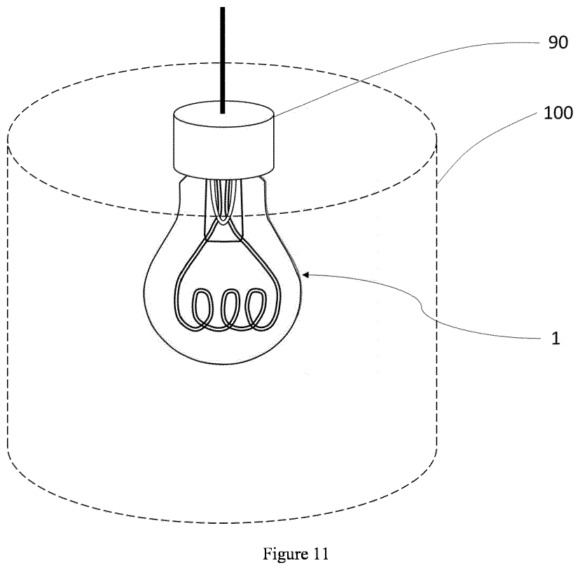

FIG. 11 shows a luminaire 100. The lighting device 1 preferably has a base 70 configured to electrically and mechanically connect the lighting device 1 to a socket 90 of a luminaire 100.

This invention is not limited to lighting devices shaped as conventional light bulbs with a translucent envelope or with an envelope coated with luminescent material on the inner side 11, and provided with a standardised base 70. The invention also applies to tubular-shaped lamps with, for instance, the connectors at both ends of the tube, but also non-compatible lighting devices may be considered.

1. A lighting device providing device light and comprising at least:
a light-transmissive envelope;
a stem at least partly arranged inside the envelope, at least part of the stem defining a first volume while a second volume is defined between the stem and the envelope;
a light guide having a melting temperature higher than the melting temperature of the stem and the melting temperature of the light guide is higher than the melting temperature of the envelope, the light guide being partly arranged inside the first volume, partly arranged inside the second volume, and partly arranged outside the first volume and the second volume;
a solid-state light source providing light source light and being arranged outside the first volume and second volume;
wherein at least part of the light source light is coupled into the light guide at a first end of a light guide portion being arranged outside the first volume and the second volume, and is light-guided via total internal reflection through the light guide to a light guide portion that is arranged inside the second volume;
wherein the light guide portion of the light guide which is arranged inside the second volume comprises one or more light outcoupling means configured to couple light-guided light out the light guide as outcoupled light into the second volume.

2. The lighting device according to claim 1, wherein the second volume is gastightly sealed by the envelope and comprises optionally a gas.

3. The lighting device according to claim 1, wherein the first volume comprises a gas.

4. The lighting device according to claim 1, wherein the light guide comprises at least an optical fiber comprising a core and a cladding, wherein the cladding has a refractive index lower than the said core.

5. The lighting device according to claim 4, wherein the melting temperature of the core and the melting temperature of the cladding are higher than the melting temperature of the stem and optionally higher than the melting temperature of the envelope.

6. The lighting device according to claim 1, wherein the light guide comprises at least one of silica, fluorine-doped glass and quartz.

7. The lighting device according to claim 1, wherein the stem comprises an exhaust tube defining a defined volume wherein the light guide is partly arranged inside.

8. The lighting device according to claim 1, wherein the solid-state light source comprises a laser light source.

9. The lighting device according to claim 1, wherein the out-coupled light is white light having a correlated color temperature in a range from 1500K to 6500K and having a color rendering index of at least 80.

10. The lighting device according to claim 1, wherein the light source light is a blue light source light, and wherein the light out-coupling means comprises a light converting material to at least partly convert blue light source light into converted light.

11. The lighting device according to claim 1, wherein the solid-state light source is arranged in a base of the lighting device; said base being configured to electrically and mechanically connect the lighting device to a socket of a luminaire.

12. The lighting device according to claim 1, wherein the light outcoupling means comprise reflective elements, scattering elements, refracting elements and/or diffractive elements arranged in or on the surface of the light guide.

13. The lighting device according to claim 1, wherein the light guide portion inside the second volume has a spiral or helix shape.

14. The lighting device according to claim 1, wherein the light source light is emitted by the solid-state light source in a direction away from an inner surface of the envelope.

15. A lamp or luminaire comprising the lighting device according to claim 1.
